(19) United States
(12) Patent Application Publication
(10) Pub. No.: US 2014/0278465 A1
(43) Pub. Date: Sep. 18, 2014

(54) METHOD, APPARATUS, AND SYSTEM FOR PROVIDING HEALTH MONITORING EVENT ANTICIPATION AND RESPONSE

(71) Applicant: AVAYA INC., Basking Ridge, NJ (US)

(72) Inventor: Robert C. Steiner, Broomfield, CO (US)

(73) Assignee: AVAYA INC., Basking Ridge, NJ (US)

(21) Appl. No.: 13/836,723

(22) Filed: Mar. 15, 2013

(51) Int. Cl. G06F 19/00

(52) U.S. Cl. CPC G06F 19/3418
USPC 705/2

(57) ABSTRACT

A contact center is described along with various methods and mechanisms for administering the same. In particular, the contact center may be configured to execute a work assignment engine and the contact center may also contain a health monitoring module that is configured to monitor events in the work assignment engine, compare the monitored events with a grammar defining expected events and an expected sequence of the expected events, and determine whether the work assignment engine is behaving appropriately based on the comparison.

### FIELD OF THE DISCLOSURE

The present disclosure is generally directed toward communications and more specifically toward contact centers.

### BACKGROUND

Contact centers can reach out or respond to customer requests to provide sales, customer service, and technical support. A typical contact center includes a switch and/or server to receive and route incoming packet-switched and/or circuit-switched work items and one or more resources, such as human agents and automated resources (e.g., Interactive Voice Response (IVR) units), to manage requests. As products and services become more complex and contact centers evolve to greater efficiencies, new methods and systems are created to monitor performance and strategies are created to deal with and minimize the impact of service outages.

Resource allocation systems in contact centers provide resources for performing tasks. The resource allocation system, or work assignment engine, uses task scheduling to manage execution of such tasks. As the number of agents, work items, tasks, and responsibilities of the work assignment engine increase, the more monitoring and reliability capabilities are needed. An administrator of a typical work assignment engine has to monitor the operational health of complex and often distributed sites based on objectives and features defined by the contact center. With the responsibility for so many tasks, things can go wrong. It is critical that the administrator has resources to handle problems as they arise.

Contact centers have strategies to manage errors and outages, often referred to as events. How well the contact center is running, also known as the health of a system, is measured by the number and severity of the events. Most contact center systems write events into an event log when things go wrong. These events typically get assigned a number, a unique ID, and included in that number is an error code. The error code is typically correlated to an error table. Once the error is recognized, an alert may be generated. Programs have been developed that can search for error codes and send out alerts, based on finding the error code in the logs. System administrators and/or engineers can search the logs manually for events. These methods are well-known, time-consuming ways for system administrators to find out what is wrong with the system. Sometimes the alerts are also sent to the work assignment engine, disrupting the flow or causing the work assignment engine to drop calls. These alerts take time and resources to generate and send, and the ability to react to them quickly may be lost. Disruption to the operation of the work assignment engine is expensive as well. The standard practices are tedious, slow, and unsophisticated. The need for more efficient, intelligent, and sophisticated health monitoring has exceeded the abilities of the current solutions.

### SUMMARY

It is with respect to the above issues and other problems that the embodiments presented herein were contemplated. In particular, embodiments of the present disclosure provide a system that is configured to learn what normal or expected operations are, collect and correlate information in real-time to catch abnormal or unexpected operations prior to a fault, and respond to the abnormal or unexpected operations quickly and efficiently, thereby preserving resources.

With a learning event system, embodiments of the present disclosure create grammars for each contact flow in the contact center. The system is operable to learn how a normal sequence should progress when there are no operational problems and creates the grammar based on the steps of the normal sequence of operations. In this case, the contact flows are standard contact center operations where each operation or step is represented by the grammar specific to the contact flow. In accordance with embodiments, each of these grammars differs in composition with respect to the other grammars.

In accordance with embodiments of the present disclosure, grammars serve enhanced functions. Logs can be created to capture events in the system. Once the grammars have been established, each grammar knows its normal sequence of events. The grammar may detect a problem before an error occurs and is logged in the system and because of this knowledge can initiate corrective action before the error occurs. The grammar, in some embodiments, can alert the system and the system administrator in a variety of ways, proactively responding to an event before the problem manifests as an outage.

For example, if a grammar defines a normal operation on a newly received work item as: (1) firstly receiving a contact; (2) secondly generating a work item representation of the contact in the contact center; (3) thirdly assigning the work item to an IVR resource to obtain more information from a customer; (4) fourthly receiving the work item back at the work assignment engine from the IVR resource; (5) fifthly scanning resources for available and qualified resources; (6) sixthly selecting a resource; (7) seventhly assigning the resource to the work item; (8) eighthly determining that the work item has been resolved; and (9) at any time discarding the work item if the customer hangs up or terminates the contact. If, for any particular work item, some step of the normal grammar is violated (e.g., step (8) precedes step (2)), then the system can detect the grammar violation, determine that an abnormal or unexpected series of events has occurred, and in response thereto take one or more corrective measures.

An additional embodiment could include setting very specific parameters (i.e., how many times an event is seen before action is taken). Another embodiment might be to expand the monitoring and notification to monitor the health of the entire contact center (in contrast to just one server or events related to individual items processed by the work assignment engine). Still another embodiment might be to create graphs and graphics for administrators to see the normal and abnormal operations and actions taken to correct issues.

Accordingly, embodiments of the present disclosure provide a method of monitoring events in a computation system, the method comprising:

building a grammar that defines a series of events that can occur in the computation system as well as an expected order of the series of events;

monitoring event flows in the computation system;

comparing the monitored flows with the grammar; and

based on the comparison of the monitored flows with the grammar, determining that an abnormal series of events has occurred in the computation system.

As used herein, the term “grammar” refers to a defined order of elements (e.g., operations, steps, associations, dialogs, requests, responses, and combinations thereof). The order of such elements in a grammar may be used to define a normal or expected behavior in a computing environment. More detailed types of elements that can belong to a grammar include: actors (e.g., things with a role), responses (e.g., actions that can occur after a first action), requests (e.g., things an actor can initiate), associations (e.g., relationships between actors), dialog (e.g., request/response interactions between actors), sequences (e.g., serial or parallel order of a dialog), and loops (e.g., repetitive dialogs). The stages of building a grammar, as will be discussed in further detail herein, may include: (1) identifying elements, (2) identifying dialogs, (3) identifying loops, and (4) identifying acceptable probabilistic ranges of properties on elements, dialogs, and loops.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored. When the computer-readable media is configured as a database, it is to be understood that the database may be any type of database, such as relational, hierarchical, object-oriented, and/or the like.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram of a communication system in accordance with embodiments of the present disclosure;

FIG. 2 is a block diagram depicting exemplary pools and bitmaps that are utilized in accordance with embodiments of the present disclosure;

FIG. 3 is an example of a data structure used in accordance with embodiments of the present disclosure;

FIG. 4 is an example of a grammar used in accordance with embodiments of the present disclosure; and

FIG. 5 is a flow diagram depicting a method for grammar learning and early error notification in accordance with an embodiment of the present disclosure.

### DETAILED DESCRIPTION

While embodiments of the present disclosure will be primarily described in connection with a work assignment engine executing operations and decisions in a contact center environment, it should be appreciated that embodiments of the present disclosure are not so limited. More specifically, embodiments of the present disclosure can be applied to any computational system that performs operations, where there can be a grammar built that defines an expected or normal sequence for those operations. Accordingly, embodiments of the present disclosure should not be construed as being limited to contact centers only.

FIG. 1 is a block diagram depicting components of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. Patent Publication No. 2010/0296417 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating tasks based thereon are described in U.S. Patent Publication Nos. 2010/0235218, 2011/0125826, and 2011/0125793, to Erhart et al, filed Mar. 20, 1010, Feb. 17, 2010, and Feb. 17, 2010, respectively, the entire contents of each are hereby incorporated herein by reference in their entirety.

The format of the work item may depend upon the capabilities of the communication device 108 and the format of the communication.

In some embodiments, work items and tasks are logical representations within a contact center of work to be performed in connection with servicing a communication received at the contact center (and more specifically the work assignment mechanism 116). With respect to the traditional type of work item, the communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 which initiated the communication with the assigned resource 112.

Although the routing engine 128 is depicted as separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smartphone, telephone, or combinations thereof. In general, each communication device 108 may be adapted to support video, audio, text, and/or data communications with other communication devices 108 and with resources 112 of the work assignment mechanism 116. The type of medium used by the communication device 108 to communicate with other communication devices 108 or resources 112 of the work assignment mechanism 116 may depend upon the communication applications available on the communication device 108. Additionally, an administrator communication device 132 may be used in conjunction with the work assignment mechanism 116 to monitor the health of the system. Examples of a suitable administrator communication device 132 include, but are not limited to, a desktop computer, a laptop, a tablet, a smartphone, other user interfaces, or combinations thereof. In general, each administrator communication device 132 may be operable to support all types of communication and management interactions with some or all elements in the system 100.

In accordance with at least some embodiments of the present disclosure, the work item is sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment engine 120 can generate bitmaps/tables 124 and determine, based on an analysis of the bitmaps/tables 124, which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching by utilizing the bitmaps/tables 124 and any other similar type of data structure. In other words, one type of work assignment algorithm that may be executed by the work assignment engine 120 may utilize the bitmaps/tables 124. It should be appreciated that the work assignment engine 120 may execute other types of work assignment strategies without departing from the scope of the present disclosure. For instance, the work assignment engine 120 may execute skills-based routing in which one or more skill queues are employed.

Regardless of the algorithm or algorithms that are employed by the work assignment engine 120, there may be a need to monitor the performance of the work assignment engine 120 and, if possible, determine whether the work assignment engine 120 is behaving as expected. In some embodiments, a health monitoring module 136 may be provided in or connected to the work assignment mechanism 116. The health monitoring module 136 may be configured to learn an expected or normal behavior of the work assignment engine 120 (e.g., by monitoring its behavior during a testing period, by monitoring its behavior during a period that has been externally verified as normal by a human administrator, by programming of the grammar by a human administrator, etc.). The health monitoring module 136 may then be configured to constantly monitor decisions or work flows performed by the work assignment engine 120, compare those work flows to the grammars (e.g., grammars defining normal or expected steps in work flows), and determine if the work assignment engine 120 is behaving or misbehaving based on the comparison of the work flows to the grammars.

As can be appreciated, the work assignment engine 120, bitmaps/tables 124, and/or health monitoring module 136 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

FIG. 2 depicts exemplary data structures 200 which may be incorporated in or used to generate the bitmaps/tables 124 used by the work assignment engine 120—as one example of a work assignment algorithm that can be followed by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center at any given time.

In some embodiments, the population of the work pool 204 may be limited to work items waiting for service by or assignment to a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed to a value representing the fact that the work item is not assigned to a resource 112, thereby making the resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item 228, 232 in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Accordingly, the values in the bitmaps 208, 216, 224 may be recalculated each time the state of a pool changes (e.g., when a work item surplus is detected, when a resource surplus is detected, etc.).

FIG. 3 is a diagram depicting an example of a data structure 300 used for error detection by the health monitoring module 136 in accordance with embodiments of the present disclosure. The illustrative data structure 300 may correspond to a sequence of expected events as well as a sequence of actual events (e.g., computation events, decisions, considerations during decisions, etc.). A plurality of expected events (e.g., events 304, 308, 312, 316, 320, 324, and 328) and their expected sequential relationship are described in the data structure 300.

The data structure 300 also shows added or unexpected events 332 and/or sequences (e.g., added unexpected sequence from event 328 to event 316) that can be detected by the health monitoring module 136. In the event that the health monitoring module 136 detects the occurrence of an unexpected event 332 or an unexpected sequence not defined by the grammar of the data structure 300, the health monitoring module 136 may determine that an error has occurred during a work flow executed by the work assignment engine 120. Most often, errors or unexpected events occur in the form of new and unexpected events 332 and/or new or unexpected sequences between expected events. Other errors may be detected by determining that an event has been skipped (e.g., this may also be referred to as an unexpected sequence between expected events) or that an event never occurred. For instance, if the work assignment engine 120 entered an infinite loop and never assigned a work item to a resource, then the health monitoring module 136 may detect that the work flow stalled at a particular expected event.

FIG. 4 is a more detailed example of a grammar 400 that may be defined for the expected behavior of the work assignment engine 120 in a contact center environment in accordance with embodiments of the present disclosure. As shown in the illustrative grammar 400, the first expected event 404 may correspond to an add work item event. A next possible event may either be a second expected event 408 (e.g., update information for the work item) or a third expected event 412 (e.g., an offer of the work item to a resource 112). Yet another next possible step after the first expected event 404 is a terminal event 428 (e.g., removal of the work item).

As the grammar continues from the third expected event 412, the grammar 400 may define either a fourth expected event 416 (e.g., rejection of the offer) or a fifth expected event 420 (e.g., an acceptance of the offer). The fourth expected event 416 may then be followed in the grammar 400 by the terminal event 428, whereas the fifth expected event 420 may be followed by a sixth expected event 424 (e.g., completion of processing the work item and assignment of the work item to the accepted resource).

As can be appreciated, the health monitoring module 136 may continuously compare decisions and computational executions performed by the work assignment engine 120 to determine if the grammar 400 is being followed. If the health monitoring module 136 detects a violation of the grammar 400 (e.g., as depicted in FIG. 3), then the health monitoring module 136 may create an error message, advise a system administrator, and/or perform one or more remedial measures to address the error.

As can be appreciated, the health monitoring module 136 may be configured to update the grammar 400 periodically by learning additional normal behaviors of the system over time. Accordingly, a first violation of the grammar 400 may be treated as an error, whereas if that first violation is confirmed as acceptable by a system administrator or the first violation begins to repeat itself with some regularity and without further concern by the system administrator, then the grammar 400 may be updated to include the a new event or sequence that describes the event or sequence previously thought to be a violation.

Aspects of the present disclosure also provide the ability to generate and update grammars 400. In some embodiments, a grammar 400 for a computational system may not be initially known. However, it may be possible for the health monitoring module 136 to passively observe the behavior of the system during runtime (e.g., observe the work assignment engine 120) and see what elements are created during run time, what relationships are created between the elements, etc. As time progresses, the health monitoring module 136 may determine that certain events and/or elements are occurring with more than a predetermined amount of frequency and, therefore, the health monitoring module 136 may add those events and/or elements to the grammar 400. A grammar 400 may be built by observing and combining several dialogs and sub-dialogs. For instance, the grammar 400 may comprise one ADD dialog defined as ADD followed by OFFER OR UPDATE OR REMOVE. The OFFER dialog following the ADD dialog may have its own definition, such as OFFER followed by REJECT OR ACCEPT. Any event or element occurring immediately after the OFFER other than REJECT or ACCEPT may be treated as an anomaly (e.g., error condition) or it may be reported to an administrator to determine if the newly-detected event or element should be added to the OFFER dialog, thereby updating the entire grammar 400.

The building of a grammar 400 may begin with creating the definition of elements within a grammar 400 or a building block of a grammar 400 (e.g., a dialog, loop, sequence, association, request, response, actor, etc.). After the elements of the grammar 400 have been defined, more specific dialogs and loops/connections between dialogs are determined. At this point, the grammar 400 likely resembles an ordered sequence of expected events, such as is depicted in FIG. 4. However, an additional step of grammar validation may be required. This step may require human user input to confirm that the sequences of the grammar are valid and should be used as a definition of normal behavior.

FIG. 5 is a flow diagram depicting a method for grammar learning and early error notification in accordance with an embodiment of the present disclosure. While a general order for the steps of the method 500 are shown in FIG. 5, the method 500 can include more or fewer steps or the order of the steps can be arranged differently than those shown in FIG. 5. The method 500 can be executed as a set of computer-executable instructions executed by a computer system and encoded or stored on a non-transitory computer readable medium.

Generally, the method begins with a work item or task that comes into a work assignment engine 120 within a work assignment mechanism 116. The work assignment engine 120 may determine that a contact flow has occurred. Based on the information delivered from the contact flow, the health monitoring module 136 can learn normal operations for the work assignment engine 120 (step 504). In some embodiments, the contact flow may be determined based on handling one work item or task. The health monitoring module 136 can determine if building a grammar is necessary (step 508). Once the health monitoring module 136 has developed an appropriate grammar 400, the work assignment 120 engine may begin the process of monitoring the contact flow that correlates to the grammar 400 (step 512).

The method proceeds by applying the grammar 400 to the monitored work flow (step 516) and compiling a log file describing the work flow (step 520). Based on the analysis performed by the health monitoring module 136 in steps 512, 516, and 520, a determination is made as to whether or not a new event at the work assignment engine 520 has been detected (step 524). If the query of step 524 is answered negatively, then the method returns to step 512.

If, however, a new event or event sequence is detected (e.g., some event or event sequence other than those defined within the grammar 400), then the health monitoring module 136 pinpoints the event within the complied log file (step 528), correlates that event to the abnormal operational sequence (step 532), and reports the abnormal or unexpected operational sequence (step 536). In some embodiments, the abnormal or unexpected operational sequence may be reported to a system administrator at the administrator communication device 132. In some embodiments, the health monitoring module 136 also provide a pre-event notification of the detected abnormal sequence to a system administrator or to some other mechanism (e.g., the work assignment engine 120) to enable the work assignment engine 120 to be corrected prior to the occurrence of the error (step 540). This pre-event notification is possible because the detection of a grammar violation may often occur before the entire error is completed. Instead, an error often results in a terminal decision that is preceded by one or more pre-terminal and erroneous conditions. Accordingly, a detection of a pre-error condition by analysis of the grammar 400 may help detect and prevent errors from occurring.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of monitoring events in a computation system, the method comprising:
building a grammar that defines a series of events that can occur in the computation system as well as an expected order of the series of events;
monitoring event flows in the computation system;
comparing the monitored flows with the grammar; and
based on the comparison of the monitored flows with the grammar, determining that an abnormal event or series of events has occurred in the computation system.

2. The method of claim 1, wherein the abnormal event or series of events is detected by detecting at least one event not defined by the grammar.

3. The method of claim 1, wherein the abnormal event or series of events is detected by detecting at least one event sequence not defined by the grammar.

4. The method of claim 3, wherein the detected at least one event sequence is detected between two expected events in the series of events.

5. The method of claim 1, wherein the grammar is a tree-structured grammar in which the series of events are ordered temporally with the first event expected to occur in the series of events corresponding to a root node of the tree-structured grammar.

6. The method of claim 1, wherein the computation system comprises a work assignment engine in a contact center and wherein the event flows correspond to decisions made by the work assignment engine.

7. The method of claim 6, wherein the grammar is at least partially based on knowledge of a work assignment algorithm expected to be performed by the work assignment engine.

8. The method of claim 7, wherein the work assignment algorithm comprises a queueless contact center algorithm.

9. The method of claim 1, further comprising:
learning a new behavior for the computation system; and
adding the new behavior to the series of events in the grammar.

10. A non-transitory computer-readable medium comprising processor-executable instructions, the instructions comprising:
instructions configured to build a grammar that defines a series of events that can occur in the computation system as well as an expected order of the series of events;
instructions configured to monitor event flows in the computation system;
instructions configured to compare the monitored flows with the grammar; and
instructions configured to determine that an abnormal event or series of events has occurred in the computation system based on the comparison of the monitored flows with the grammar.

11. The computer-readable medium of claim 10, wherein the abnormal event or series of events is detected by detecting at least one event not defined by the grammar.

12. The computer-readable medium of claim 10, wherein the abnormal event or series of events is detected by detecting at least one event sequence not defined by the grammar.

13. The computer-readable medium of claim 12, wherein the detected at least one event sequence is detected between two expected events in the series of events.

14. The computer-readable medium of claim 10, wherein the grammar is a tree-structured grammar in which the series of events are ordered temporally with the first event expected to occur in the series of events corresponding to a root node of the tree-structured grammar.

15. The computer-readable medium of claim 10, wherein the computation system comprises a work assignment engine in a contact center and wherein the event flows correspond to decisions made by the work assignment engine.

16. The computer-readable medium of claim 15, wherein the grammar is at least partially based on knowledge of a work assignment algorithm expected to be performed by the work assignment engine.

17. The computer-readable medium of claim 10, the instructions further comprising:
instructions configured to learn a new behavior for the computation system; and
instructions configured to add the new behavior to the series of events in the grammar.

18. A contact center, comprising:
a work assignment engine executed in one or more servers, the work assignment engine being configured to make work assignment decisions for work items received in the contact center; and
a health monitoring module configured to build a grammar that defines a series of events that can occur in the work assignment engine as well as an expected order of the series of events, monitor event flows in the work assignment engine, compare the monitored flows with the grammar, and determine that an abnormal event or series of events has occurred in the work assignment engine based on the comparison of the monitored flows with the grammar.

19. The contact center of claim 18, wherein the abnormal event or series of events is detected by detecting at least one event not defined by the grammar.

20. The contact center of claim 18, wherein the abnormal event or series of events is detected by detecting at least one event sequence not defined by the grammar.
